(19) United States
(12) Patent Application Publication
(10) Pub. No.: US 2008/0172301 A1
(43) Pub. Date: Jul. 17, 2008

(54) Boomtime

(76) Inventor: William F. Bice, Sandia Park, NM (US)

Correspondence Address: ORTIZ & LOPEZ, PLLC, P.O. BOX 4484, ALBUQUERQUE, NM, 87196-4484, US

(21) Appl. No.: 11/652,261

(22) Filed: Jan. 11, 2007

(51) Int. Cl. G06Q 30/00

(52) U.S. Cl. 705/26

(57) ABSTRACT

A facilitator supports numerous organizations that supply personal services by providing infrastructure and a management interface for controlling and customizing the infrastructure. The infrastructure includes databases, a web site, scheduling tools, and sales tools. The sales tools can offer both personal services and goods, such as shampoo or lotion. The personal services can be purchased for direct use by the purchaser or as a gift to a recipient. The recipient can receive a gift certificate electronically, through the mail, or delivered by hand. A traveling client can select an organization far from home based on proximity or availability.

### TECHNICAL FIELD

Embodiments relate to the fields of personal services related businesses, web browsers, client/server computer architectures. Embodiments also relate to web based layout tools, web page design, design templates, databases, and internet based commerce.

### BACKGROUND

Many small personal services related businesses, such as health spas, use ad hoc methods for handling their operations. For example, point of sale systems are not tied in any way to scheduling. Furthermore those businesses that do use computer based solutions use lowest common denominator solutions. An example of a lowest common denominator solution is a health spa in Oregon using the same solution as a golf pro shop in Florida. Both businesses have an adequate solution, but neither has a good one.

Web site design tools have existed for almost as long as the web itself. Some tools provide systems and methods for building an internet store. For example, Cafe Press offers systems and methods for creating an internet t-shirt store. Designs can be entered, and web pages for presenting designs and taking orders are provided. The back end databases for supporting the t-shirt store are also provided as are systems for payment, t-shirt production, and shipping. Customers, however, associate the transaction with Cafe Press because the materials are branded as such.

An aggregation model is used for buying and selling gift certificates over the internet. In an aggregation model, the gift certificate is purchased from an aggregator, such as Amazon, and can be redeemed by purchasing goods from any of a number of associated businesses. The aggregator receives the funds when the gift certificate is sold. After redemption, an associate presents the gift certificate to the aggregator at which time the aggregator pays the associate.

In the non-virtual world, there are multitudes of small personal services related businesses. Systems and methods are needed to supply those businesses with a virtual storefront while meeting the special requirements of small personal services related businesses.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

Limitations in current technology can be addressed by providing a container application that, unlike a web browser, does allow web based applications to control and alter meta UI areas of windows associated with the container application.

It is therefore an aspect of the embodiments to provide a client computer connected to a communications network. A server is also connected to the communications network. The client computer uses a display device to present information to a user. The user uses at least one input device, such as a keyboard or mouse, to provide an input to the client computer.

It is also an aspect of the embodiments to provide a management interface. The management interface can have a number of different management pages. Some of the management pages provide a web site design interface. The web site design interface can include templates that the user can select such that the user initiates web site or web page creation by selecting a template and then modifying the template to obtain a more personalized result. A web browser running on the client computer can obtain the various pages of the management interface from the server.

It is another aspect of the embodiments to provide access to the management interface to an organization. The personnel of the organization, such as a personal services related business, can use the management interface to manage an organization web site and the services provided by way of the organization web site. Initially, the organization web site is based on a default web site, perhaps using the templates discussed above. The organization can use the web site design interface to edit, modify, and customize the organization web site.

It is a further aspect of the embodiments to host the organization web site. Hosting a web site means making the web site available on the Internet.

It is a yet further aspect of the embodiments to provide a customer database and a services database. The customer database contains information about the organization's individual customers. The services database contains information about the services provided by the organization to the customers.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a first organization, a second organization, and a third organization all using the same aggregated information systems provider in accordance with aspects of certain embodiments;

FIG. 2 illustrates a high level block diagram of a system that automatically notifies clients of upcoming events and produces event based modifications to a web site in accordance with aspects of certain embodiments;

FIG. 3 illustrates interactions involving a jurisdiction module in accordance with aspects of certain embodiments;

FIG. 4 illustrates a client seeking services in an emergency in accordance with aspects of certain embodiments;

FIG. 5 illustrates obtaining performance metrics in accordance with aspects of certain embodiments;

FIG. 6 illustrates the “Today” page of the SpaBoom website in accordance with aspects of the embodiments;

FIG. 7 illustrates a GC, or gift certificate, summary page in accordance with aspects of the embodiments;

FIG. 8 illustrates an “Add GC” page used for adding in a new gift certificate in accordance with aspects of the embodiments;

FIG. 9 illustrates a page for adding a new client in accordance with aspects of the embodiments;

FIG. 10 illustrates an Appointments page containing an appointments table in accordance with aspects of the embodiments;

FIG. 11 illustrates a “Clients” page in accordance with aspects of the embodiments;

FIG. 12 illustrates an “Add Client” page in accordance with aspects of the embodiments;

FIG. 13 illustrates a main “Reports” page that presents a Reports menu in the left side bar in accordance with aspects of the embodiments;

FIG. 14 illustrates a “Client Detail” page in accordance with aspects of the embodiments;

FIG. 15 illustrates a “Client Journal” page in accordance with aspects of the embodiments;

FIG. 16 illustrates a “Balances” page in accordance with aspects of the embodiments;

FIG. 17 illustrates a “Cash Flow” page in accordance with aspects of the embodiments;

FIG. 18 illustrates a “Report: Billing History” page in accordance with aspects of the embodiments;

FIG. 19 illustrates a main “Setup” page in accordance with aspects of the embodiments;

FIG. 20 illustrates a “Client Types” page in accordance with aspects of the embodiments;

FIG. 21 illustrates an “Events” page in accordance with aspects of the embodiments;

FIG. 22 illustrates a “GC Designs” page in accordance with aspects of certain embodiments;

FIG. 23 illustrates an “Edit GC Design” in accordance with aspects of certain embodiments;

FIG. 24 illustrates an “Edit GC Category” page in accordance with aspects of certain embodiments;

FIG. 25 illustrates a “GC Types” page in accordance with aspects of certain embodiments;

FIG. 26 illustrates an “Edit GC Type” page in accordance with aspects of certain embodiments;

FIG. 27 illustrates a “Pages” page in accordance with aspects of the embodiments;

FIG. 28 illustrates a “Page” page in accordance with aspects of the embodiments;

FIG. 29 illustrates a Header page in accordance with aspects of the embodiments;

FIG. 30 illustrates a “Professionals” page in accordance with aspects of the embodiments;

FIG. 31 illustrates an “Edit Professional” page in accordance with aspects of the embodiments;

FIG. 32 illustrates a “Services” page in accordance with aspects of the embodiments;

FIG. 33 illustrates an “Edit Service Category” page in accordance with aspects of the embodiments;

FIG. 34 illustrates a “Service” page in accordance with aspects of the embodiments;

FIG. 35 illustrates an “Edit Service” page in accordance with aspects of the embodiments;

FIG. 36 illustrates an “Add Service Category” page in accordance with aspects of the embodiments;

FIG. 37 illustrates an “Add Service” page in accordance with aspects of the embodiments;

FIG. 38 illustrates an “Add Package” page in accordance with aspects of the embodiments;

FIG. 39 illustrates a “Basics” page in accordance with aspects of the embodiments;

FIG. 40 illustrates a “Billing” page in accordance with aspects of the embodiments;

FIG. 41 illustrates an “Hours” page in accordance with aspects of the embodiments;

FIG. 42 illustrates a “Logo” page in accordance with aspects of the embodiments;

FIG. 43 illustrates a “Website” page in accordance with aspects of the embodiments;

FIG. 44 illustrates the home page for a personal services vendor in accordance with aspects of the embodiments;

FIG. 45 illustrates the services page of a personal services vendor's website in accordance with aspects of the embodiments;

FIG. 46 also illustrates the services page of a personal services vendor's website in accordance with aspects of the embodiments;

FIG. 47 illustrates the “Request Appointment” first page of a personal services vendor's website in accordance with aspects of the embodiments;

FIG. 48 illustrates the “Request Appointment” client information page of a personal services vendor's website in accordance with aspects of the embodiments;

FIG. 49 illustrates the “Instant Gift Certificate” first page of a personal services vendor's website in accordance with aspects of certain embodiments;

FIG. 50 illustrates the “Instant Gift Certificate” first page of a personal services vendor's website wherein the “Service” radio button is selected in accordance with aspects of certain embodiments;

FIG. 51 illustrates an “Instant Gift Certificate” in accordance with aspects of certain embodiments.

### DETAILED DESCRIPTION

A personal services related businesses, also called a “personal services vendor” or simply an “organization” has customers. For example, a spa is an organization and a person going to the spa is a customer. Methods and systems are needed that streamline an organization's interactions with customers while retaining the organizations unique identity and advantageously obeying the legal requirements of the organization's legal jurisdiction. A facilitator can provide the needed system and methods.

In general, the facilitator can provide organizations with tools for creating and operating a customized web site. Each organization can easily control the look and feel of its own web site without needing to know any specialized web design language. The facilitator hosts the organization's web site. The facilitator can also provide other functionality to each organization including credit card processing, customer data basing, order taking, gift certificate processing, and customer communications.

The facilitator can provide organizations with an easy way to enter and store information including service offers, service details, service descriptions, service prices. Upon entering the information, the information is stored and immediately appears in the web pages and menus comprising the organizations' web site. The information is easy to enter because there is no need to know the arcane HTML web language or any similar language.

The facilitator can also provide organizations with advanced email facilities. These facilities can be used to email newsletters to customers on a customer list, email messages to customers who have yet to redeem a gift certificate (GC), and email follow up offers. A follow up offer is an offer based on a previous purchase. For example, a husband who bought an anniversary gift certificate can be emailed to remind him of subsequent anniversaries and to make special offers. In general, the advanced email facilities can send email based on rules signifying buying habits, gift certificate status, and other factors.

The facilitator can also provide for reverse aggregation. Aggregation occurs when a customer can redeem a generalized offer at any one of a group of organizations. For example, an aggregator can sell a gift certificate to a customer. The customer can redeem the gift certificate at an organization affiliated with the aggregator. The result is that the customer associates the service with the aggregator and rarely develops a meaningful relationship with the organization. Affiliate business models and franchise business models often use aggregation.

Reverse aggregation occurs when a customer seeking a service is directed to a specific organization. For example, SpaEmergency allows a customer to search for a service based on a set of factors. The factors can include specific service, such as deep massage, geographic area, such as zip code, and availability, such as business hours or open appointments. The customer can then choose a specific spa or salon and receive a gift certificate that is branded for that specific spa or salon. The organization, here a spa or salon, is paid as soon as the customer purchases the certificate, improves cash flow by allowing revenue from unredeemed certificates, and helps prevent the customer from going to a competitor.

An example of a reverse aggregation sales cycle is:
1) Customer searches for and finds a spa or salon that they desire to purchase a gift certificate from after going to the SpaEmergency website;
2) Customer prints out an “Instant Gift Certificate” that is specifically numbered and branded to the spa or salon of interest (hereinafter “Receiving Org”). The customer is instantly gratified and can either print, postal mail or email their gift certificate;
3) The Receiving Org gets a notice from SpaEmergency that a sale was made, and SpaEmergency (vis-à-vis SpaBoom) either processes the credit card (CC) immediately, or provides CC information to enable the Receiving Org to process the CC manually using their offline merchant account;
4) SpaEmergency tallies up sales at the end of the month, and charges a commission to the Receiving Org, based on the net sales made during the month.
5) Customer's lucky recipient redeems their unique gift certificate at their leisure.
   As such, some possible reverse aggregation claims are:

The facilitator can additionally provide for third party fulfillment. Third party fulfillment occurs when suppliers, such as manufacturers or other product suppliers, and the facilitator agree to enter the supplier's products into a products database. The products data base contains product information for each product. The product information can include descriptions, pictures, pricing, and an identifier such as a stock keeping unit (SKU).

An organization can choose to use the facilitator to sell products. The facilitator provides an interface, such as a set of web pages, to the organization. The organization uses the interface to select products to sell. The selected products are automatically offered for sale on the organization's web site. The facilitator can also provide the organization with a design interface that can be used to customize the web pages containing the product offers.

When a customer purchases a product, the facilitator handles fulfillment. Fulfillment means delivering goods or services to a customer. As such, the facilitator can drop ship products from stock on hand. The facilitator can also forward information to one or more of the suppliers who then handles fulfillment. Many organizations, however, prefer branded fulfillment. To provide branded fulfillment, the products can be shipped to the customer in boxes branded for the organization and with invoices, receipts and labels branded for the organizations. For example, if Mack orders conditioner from Joe's Salon then Mack receives conditioner in a box with Joe's Salon labeling. Mack's order receipt says the order is from Joe's Salon.

FIG. 1 illustrates a first organization 101, a second organization 102, and a third organization 103 all using the same aggregated information systems provider 104. The aggregated information systems provider 104 can supply database solutions 105, client management solutions 106, accounting solutions 107, professional management solutions 108, billing solutions 110, web sites 111, jurisdiction based optimizations 109, and marketing functions 112.

Jurisdiction based optimizations are requirements or opportunities that arise based on the jurisdiction in which an organization operates. The most obvious jurisdiction based requirement is taxes. Different jurisdictions often have different taxation rates and schemes. Jurisdiction based optimizations, however, are often less obvious. For example, different jurisdictions have different rules for gift certificates. Some jurisdictions do not allow gift certificates to expire. Others impose a minimum period until expiration. Some jurisdictions allow gift certificates to simply expire while others require that the value of the certificate be reimbursed to somebody or something. Each organization can automatically enjoy customized and optimized gift certificate capabilities by using jurisdiction based optimizations 109. For example, the terms and conditions printed on the gift certificate can be based on the laws of the jurisdiction that the services provider uses.

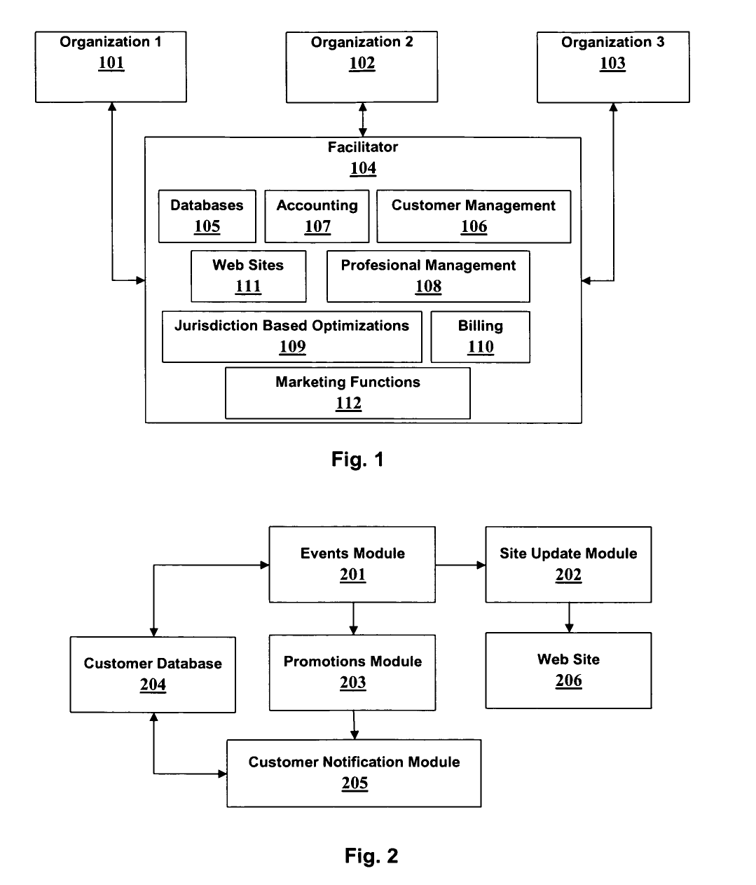

FIG. 2 illustrates a high level block diagram of a system that automatically notifies clients of upcoming events and produces event based modifications to a web site. An events module 201 keeps track of special events such as Valentines Day, Mother's Day, and client birthdays. An upcoming event can trigger a promotions module 203 that produces client notifications such as advertisements or coupons. The client notification module 205 interacts with the client database 204 and causes clients to receive the notifications. A notification can be emailed, mailed, phoned, faxed, texted, or communicated to the client in some other manner. The client database 204 can contain client notification preferences so that some clients can be emailed while others receive regular mail. This configuration also enables each organization to maintain CAN-SPAM compliance or adhere to other form of legal communications requirements.

The events module 201 also alerts a site update module 202 about an upcoming event. The site update module 202 can update a website 206. For example, one month before Mother's Day, the events module can alert the site update module 202 that Mother's Day is near. The site update module 202 can then update the website 206 with special Mother's Day content. The events module 201 also alerts the site update module 202 when there is no event near. As such, after Mother's Day, the events module 201 alerts the site update module 202 causing the web site 206 to display its normal content.

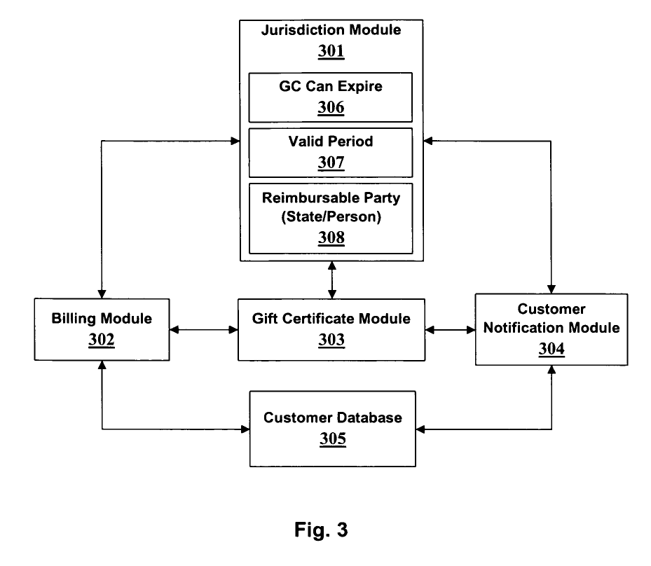

FIG. 3 illustrates interactions involving a jurisdiction module 301. The jurisdiction module 301 contains information about different laws in different jurisdictions. Here, the jurisdiction module 301 contains information regarding the legality of expiring gift certificates 306, how long gift certificates must be valid 307 and who gets the money when a gift certificate expires 308. A gift certificate module 303 can produce a gift certificate. It queries the jurisdiction module 301 to find what terms to print on the gift certificate.

A billing module 302 can collect or record payment for a gift certificate. Payment can be collected by charging a credit card. If money has already been collected, payment can be simply recorded. For example, an in person cash payment at a personal services provider's location results in money already received. In other words, someone walks into the store and buys a gift certificate with cash and a cashier uses the computer as a point of sales device (cash register) and to generate the gift certificate. Another possibility is that a client regifts by using the balance on their own gift certificate to purchase one for someone else. The billing module 302 can also interact with the jurisdiction module 301 and a client database 305.

The gift certificate (GC) module 303 can also trigger a client notification module 304 to cause delivery of the gift certificate. The client notification module 304 can interact with the client database 305 to obtain information such as the client home address or email address.

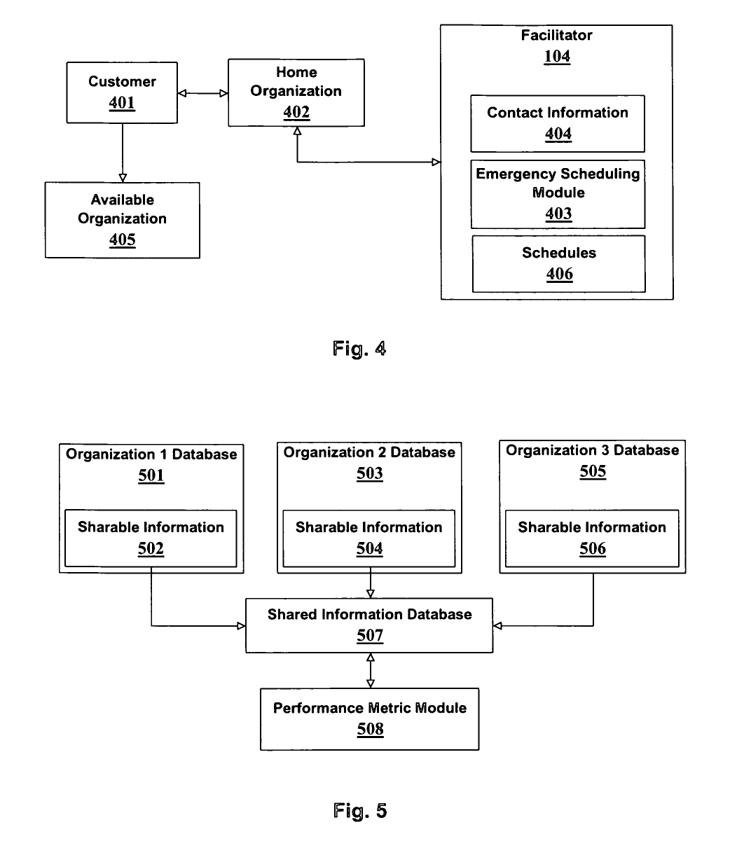

FIG. 4 illustrates a client 401 seeking services in an emergency. The client 401 contacts their home vendor 402 with whom they normally do business. The client 401 communicates the client location and schedule. The home vendor 402 passes the information to the aggregated information systems provider 104 that uses an emergency scheduling module 403. The emergency scheduling module examines the schedules 406 and contact information 404 of services providers to locate those that are available. The available service providers are those close to the client and have open schedules when the client 401 wants. Information about available service providers is passed to the client 401 by way of the home vendor 402. The client 401 can then schedule an appointment with an available services provider 405.

FIG. 5 illustrates obtaining performance metrics. A first vendor has a database 501 that contains sharable information 502. A second vendor also has a database 503 containing sharable information 504. Additionally, a third vendor has a database 505 containing sharable information 506. Each vendor can choose which information is sharable. For example, certain aggregate billing, collections, and utilization information can be shared while client data is held private. A shared information database 507 collects the shared information. A performance metric module 508 queries the shared information database 507 to assemble performance metrics. A performance metric is a measure of how well one services provider is performing a function or how well a group of services providers is performing a function. For example, a services provider interested in gross margins for his own business as compared to a group of similarly sized services providers would use the performance metric module 508 to obtain the data.

Gross margins are one performance metric. Other performance metrics include but are not limited to overall sales numbers and revenue totals (hereinafter “sales”), sales conversions, repeat sales, new sales, sales by event, sales by occasion, sales by service, sales by geographic location or region, sales by referrer, sales by search term, GC design preference, and event and occasion preferences.

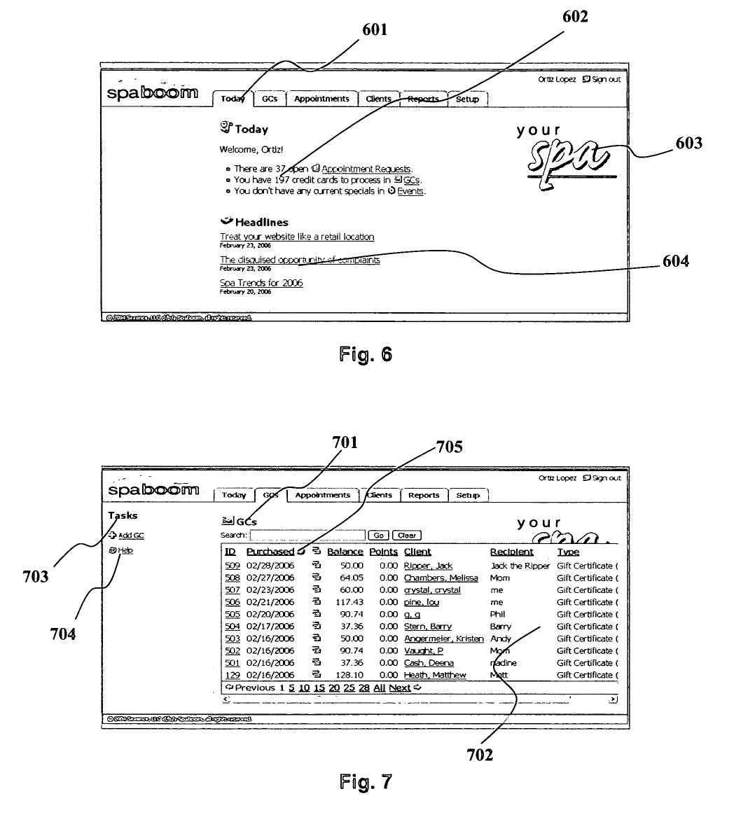

FIG. 6 illustrates the “Today” page of the SpaBoom website. The “Today” tab 601 is active. User news 602 is presented for the specific user or services vendor while headlines 604 are items of general interest. The logo 603 of the spa is presented on the right hand side of the page.

FIG. 7 illustrates a GC, or gift certificate, summary page. The GCs tab is active and the GCs locator 701 is presented. A Tasks menu 703 is presented in the left sidebar presenting options 704 to add GC or get help. A GC data table 702 is presented with each row containing data for one gift certificate. The table appears sorted in accordance with a sort arrow 705. The sort arrow can be selected to change the sort direction. Selecting a column heading can cause the table to be presented as sorted along that column. Here, the table is presented as sorted by the gift certificate purchase date with the newest purchases appearing first.

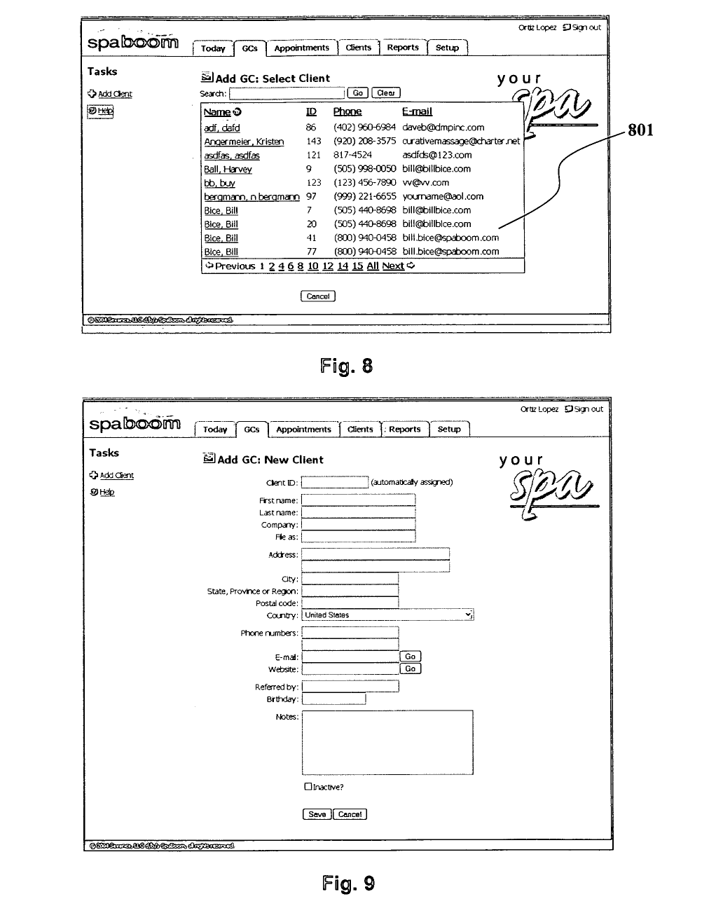

FIG. 8 illustrates the “Add GC” page used for adding in a new gift certificate. The client table 801 presents a table of clients and client information. As can be seen, the tasks menu presents the option to add a new client. FIG. 9 illustrates a page for adding a new client wherein the fields are self explanatory.

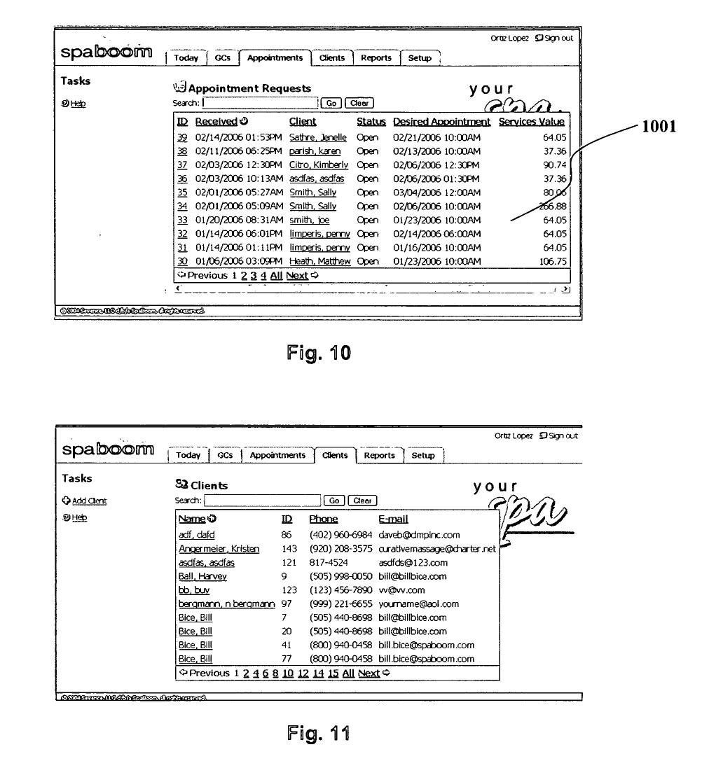

FIG. 10 illustrates an Appointments page containing an appointments table 1001. The appointments tab is active and the “Appointment Request” locator is displayed. The appointments table 1001 presents a sorted table of appointment data.

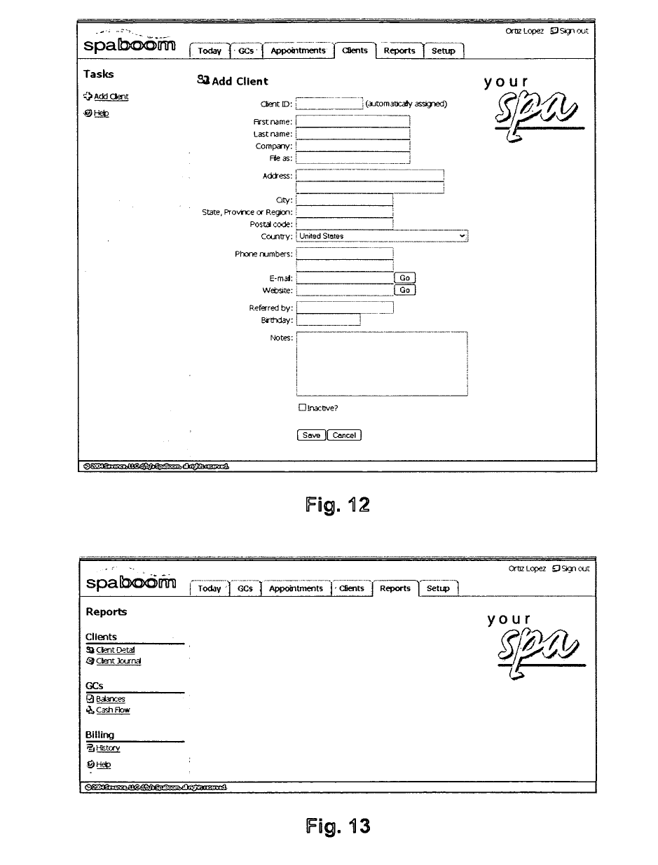

FIG. 11 illustrates a “Clients” page that is similar to that of FIG. 8. The Clients tab is active and the “Clients” locator is displayed. Notice that the FIG. 8 has the “Add GC: Select Client” locator displayed indicating that it was accessed from the GC page. Similarly, FIG. 12 presents an “Add Client” page that is similar to that of FIG. 9 with the exception of a different locator.

FIG. 13 illustrates the main “Reports” page that presents a Reports menu in the left side bar.

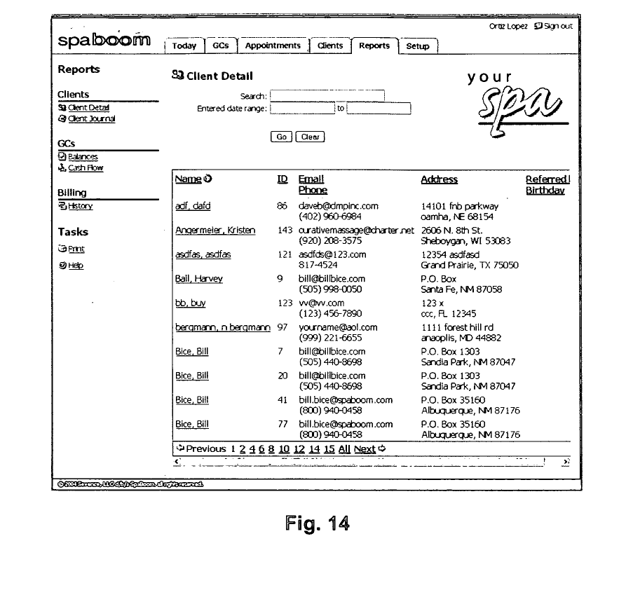

FIG. 14 illustrates the “Client Detail” page accessed via the “Client Detail” link on Reports left side bar. As can be seen, the client detail table contains more information than the client tables illustrated above.

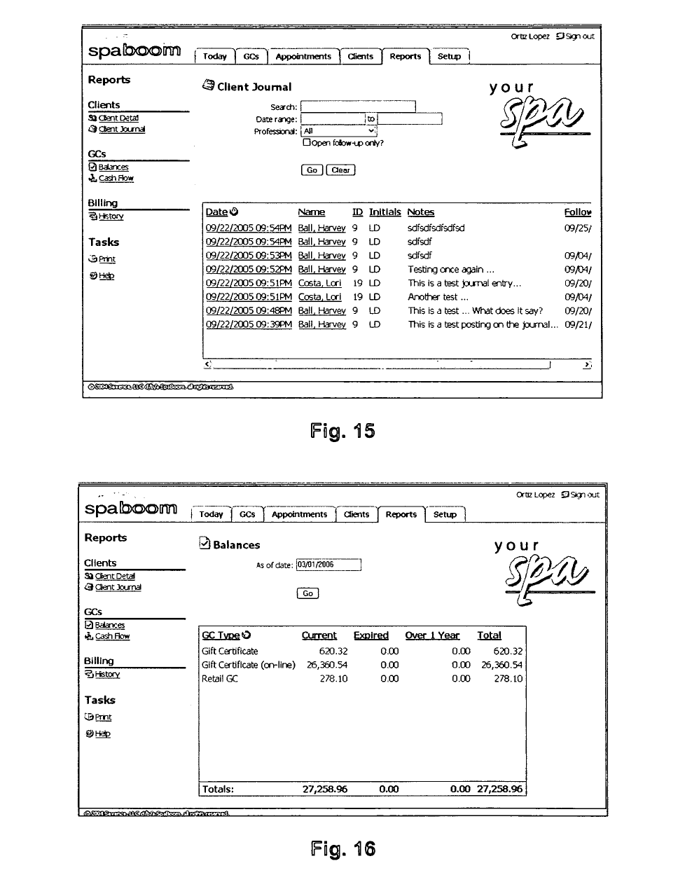

FIG. 15 illustrates the “Client Journal” page accessed via the “Client Journal” link on the Reports left side bar. The journal table has a single journal entry per row giving the date, client name and Id, the name of the journal entry creator, a note, and a date on which to follow up on the journal entry. The journal is used to log data about specific clients and events that should be remembered, communicated, or followed up.

FIG. 16 illustrates the “Balances” page accessed via the “Balances” link on the Reports left side bar. Each GC type has a row in the balances table. The balances shown are self explanatory totals for each GC type.

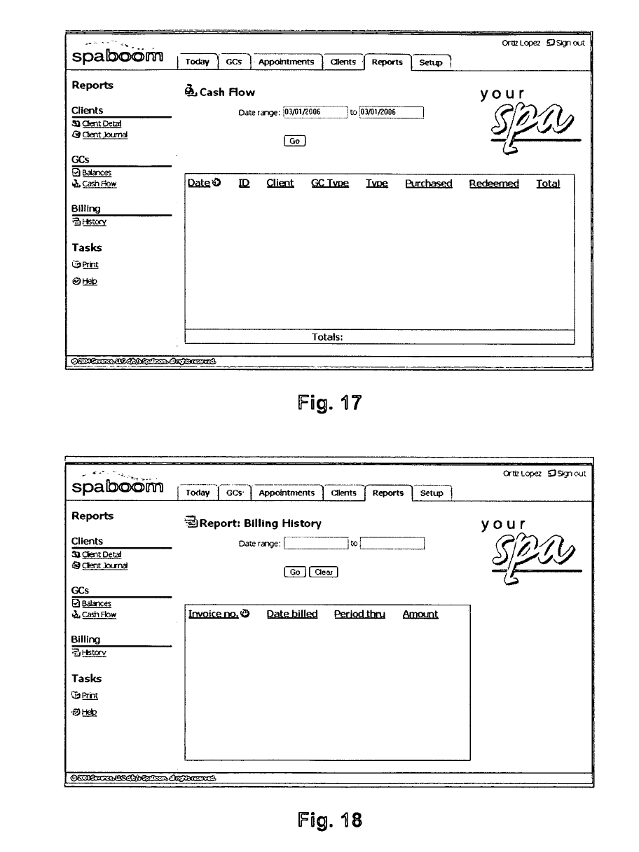

FIG. 17 illustrates the “Cash Flow” page accessed via the “Cash Flow” link on the Reports left side bar. The columnar data shown are self explanatory.

FIG. 18 illustrates the “Report: Billing History” page accessed via the “Billing History” link on the Reports left side bar. Each invoice has a row in the invoice table. The columnar data shown are self explanatory for each invoice.

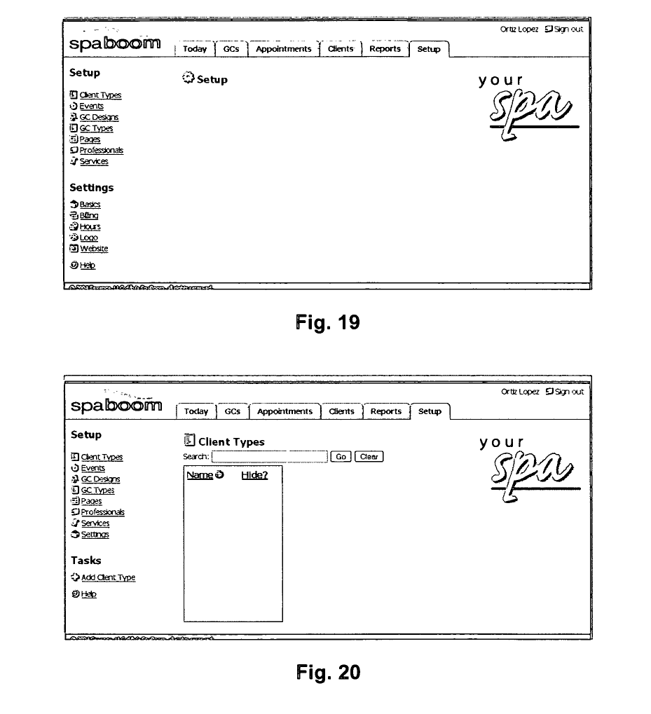

FIG. 19 illustrates the main “Setup” page that presents a Setup menu and a Settings menu in the left side bar.

FIG. 20 illustrates the “Client Types” page accessed via the “Client Types” link in the Setup menu. Each client type has a row in the client type table. The columnar data shown are self explanatory for each client type. Notice that a context sensitive tasks menu appears in the left side bar.

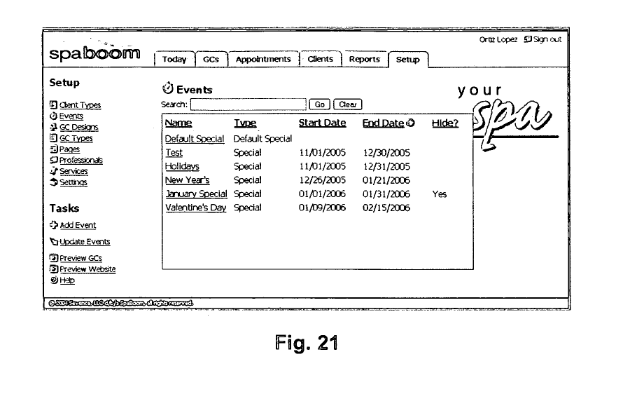

FIG. 21 illustrates the “Events” page accessed via the “Events” link in the Setup menu. Each event has a row in the client type table. The columnar data shown are self explanatory for each event. The events shown correspond to those handled by the Events Module of FIG. 2.

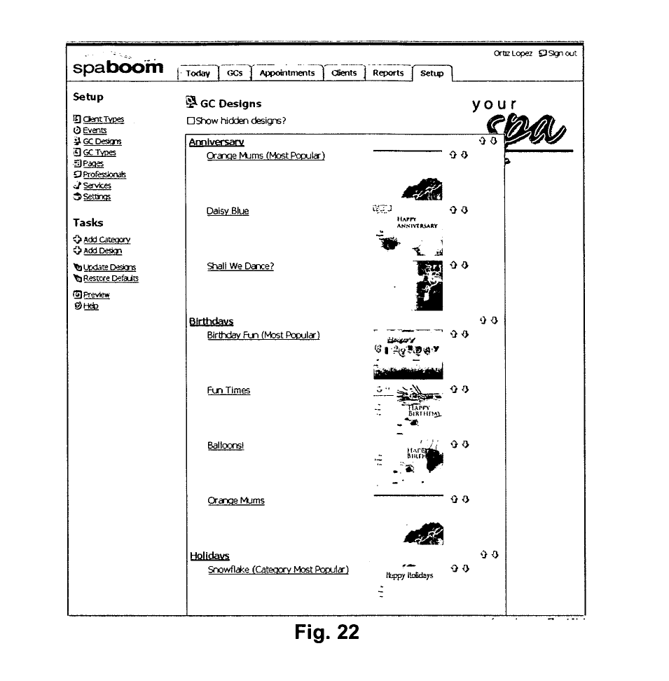

FIG. 22 illustrates the “GC Designs” page accessed via the “GC Designs” link in the Setup menu. A number of GC categories are presented such as “Anniversary”, “Birthdays”, and “Holidays”. The GC designs, such as “Orange Mums”, “Daisy Blue”, and “Shall We Dance?” are presented within a GC category. The show hidden designs button causes all of the designs and categories to be displayed. A hidden GC design or GC category is one wherein the “hidden” property is set resulting in the GC design not being displayed. Notice that the context sensitive tasks menu presents options for adding categories and designs as well as other tasks.

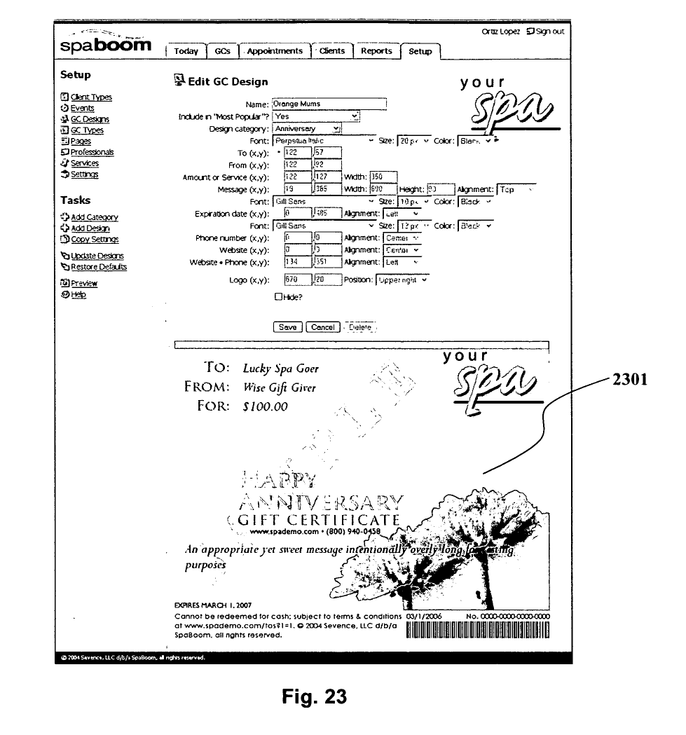

FIG. 23 illustrates the “Edit GC Design” page accessed by clicking on a GC design, such as “Orange Mums”, on the “GC Designs” page. The text entry fields are largely self explanatory. The hide button can be selected to set the design's “hidden” property. A sample GC is displayed at the bottom of the page 2301. Note that this functionality makes it possible for personal services vendors to have their own unique, custom designed GC's as part of the offering to the end customer. This makes it possible to present SpaBoom GC designs, custom GC designs, or a combination thereof to the end customers.

FIG. 24 illustrates the “Edit GC Category” page accessed by clicking on a GC category, such as “All Occasions”, on the “GC Designs” page. The text entry field is self explanatory, being used for entering and presenting the GC category identifier. The hide button can be selected to set the category's “hidden” property.

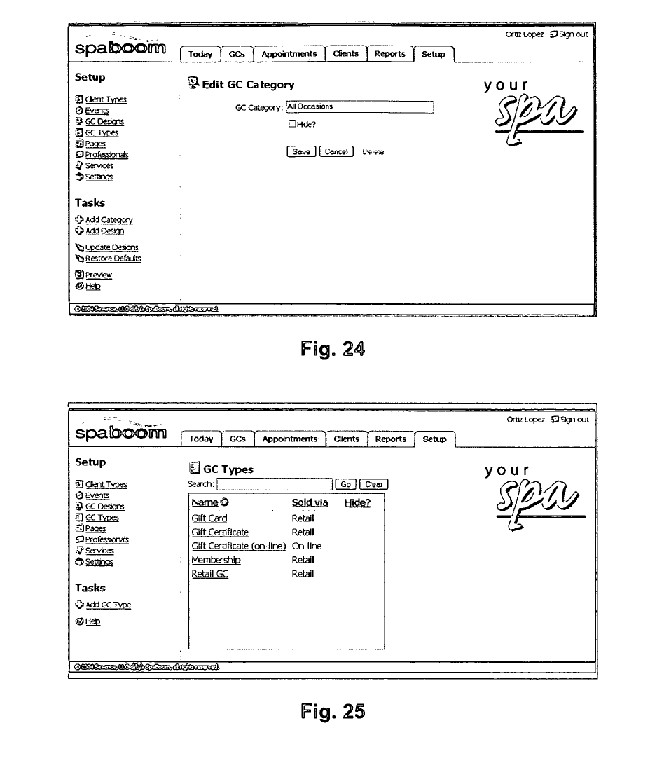

FIG. 25 illustrates the “GC Types” page accessed via the “GC Types” link in the Setup menu. Each GC type has a row in the GC type table. The columnar data shown are self explanatory.

FIG. 26 illustrates the “Edit GC Type” page accessed by clicking on a GC type on the “GC Types” page. The text entry fields are self explanatory. The track reward points check box allows the GC to be part of a rewards point program. Contemporary consumers are familiar with rewards programs wherein additional service, coupons, or cash rebates are earned. This functionality makes it possible to manage different GC types, such as GCs of different GC type having different expiration dates.

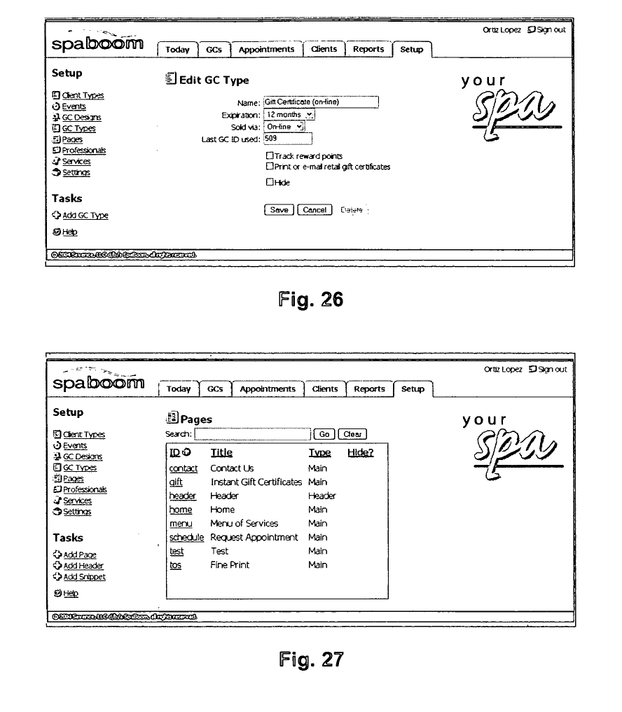

FIG. 27 illustrates the “Pages” page accessed via the “Pages” link in the Setup menu. Each page of the service provider's web site is represented by a row in the pages table. The ID is the page's identifier. The title is the text that can be displayed in a web browser's title bar when the page is displayed in the web browser's content area. The type is either “main”, “header”, or “snippet”.

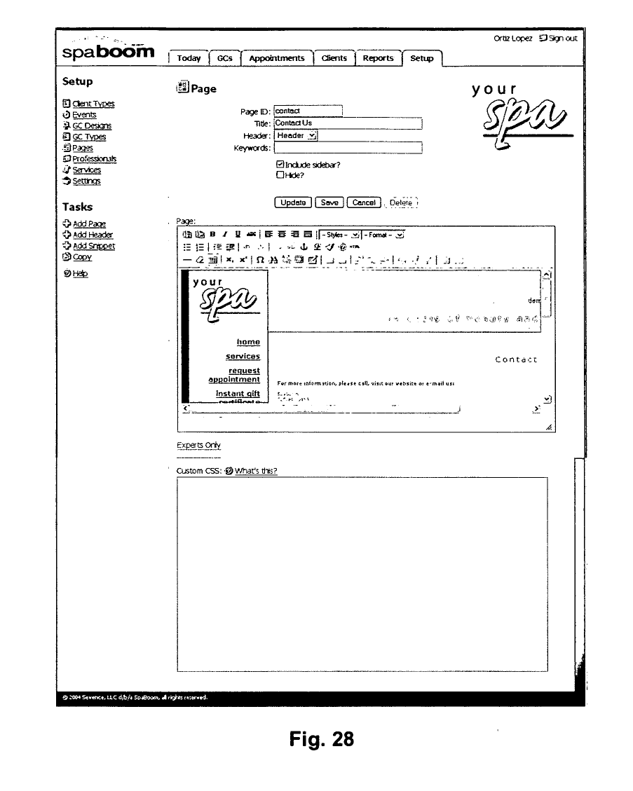

FIG. 28 illustrates the “Page” page accessed via the “Add Page” link in the context sensitive Tasks menu. The text entry fields are largely self explanatory in corresponding to fields displayed in FIG. 27. The Header property selects the web page's header. The keywords field selects certain key words that can be placed in the page as metadata helpful to search engines. A web based authoring tool 2801 can also set the pages content. The “Experts Only” link opens up the “Custom CSS” areas. Those skilled in web page design are familiar with all the aspects of web page design and editing presented in FIG. 28.

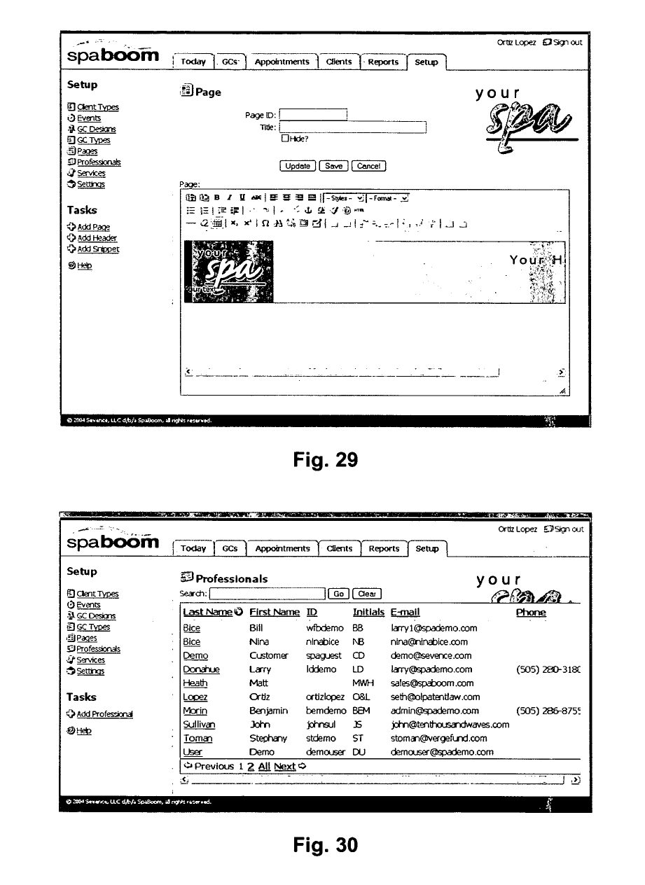

FIG. 29 illustrates the Header page, currently labeled “Page”, that can be accessed via the “Add Header” link in the context sensitive Tasks menu. The principal difference between the Header page and the “Page” page is that there is no field for selecting a header's header. Those skilled in web page design are familiar with all the aspects of web page design and editing presented in FIG. 29.

FIG. 30 illustrates the “Professionals” page accessed via the “Professionals” link in the Setup menu. A professional is a person who can perform personal services for a client. The professional can be an employee of the personal services vendor. The columnar data shown are self explanatory for each professional.

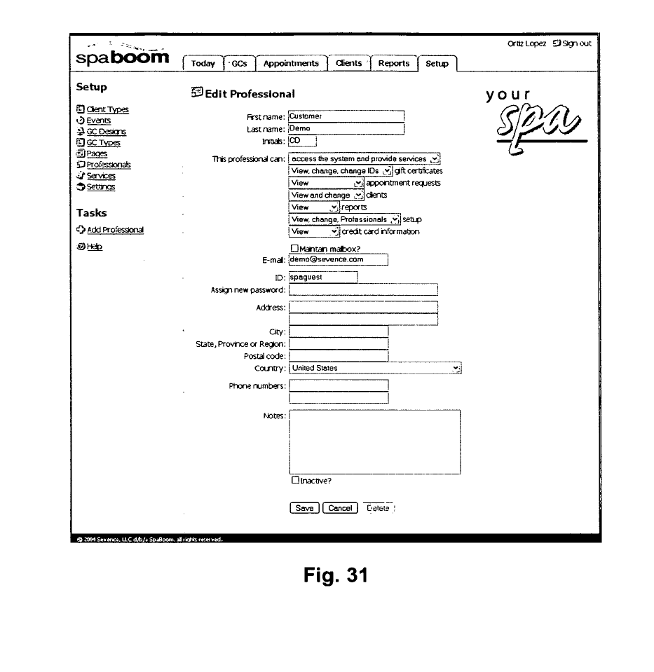

FIG. 31 illustrates the “Edit Professional” page accessed by clicking on a last name on the “Professionals” page. The text entry fields are self explanatory.

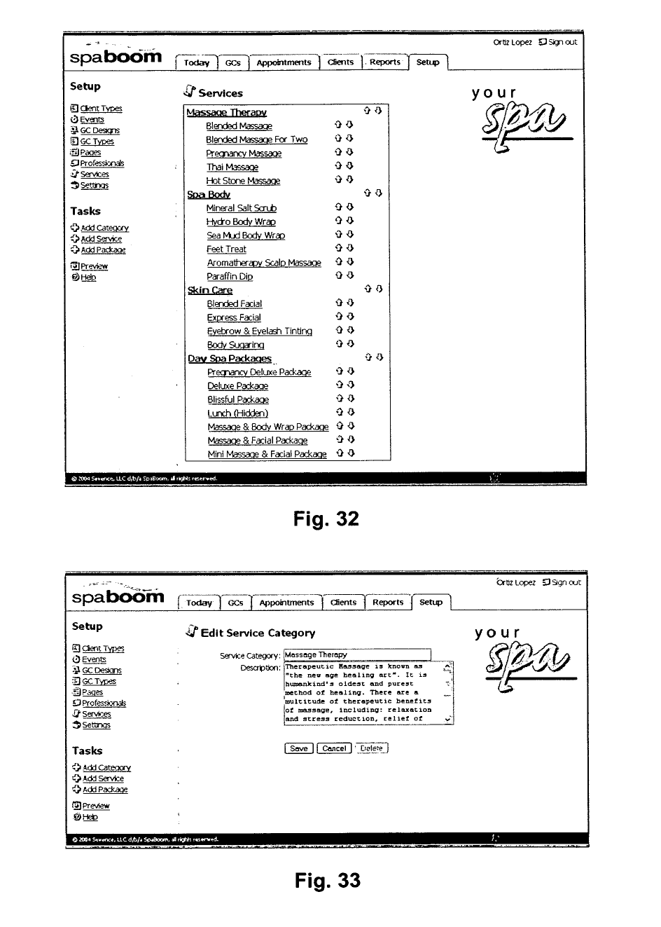

FIG. 32 illustrates the “Services” page accessed via the “Services” link in the Setup menu. Service categories, such as “Massage Therapy”, “Spa Body”, and “Skin Care” are displayed. Service packages, such as “Blissful Package”, are shown under the “Day Spa Packages” heading. Each service, such as “Blended Massage” or “Thai Massage” is presented within a service category.

FIG. 33 illustrates the “Edit Service Category” page accessed by clicking on a service category on the “Services” page. The text entry fields are self explanatory.

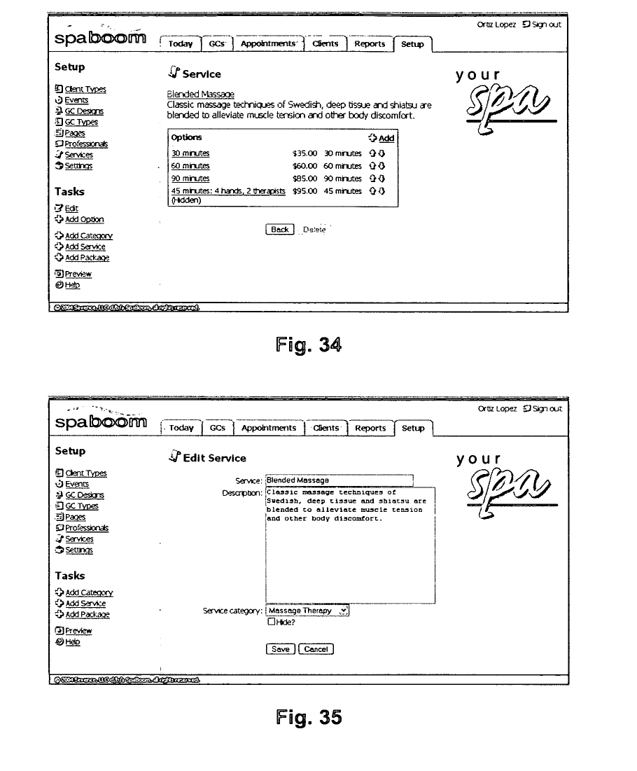

FIG. 34 illustrates the “Service” page accessed by clicking on a service on the “Services” page. Each service option is represented by a row in the service table specifying a level of personal service, price, and amount of time. Additional service options can be added by clicking the “Add” link.

FIG. 35 illustrates the “Edit Service” page accessed by clicking on a service on the “Services” page. The text entry fields are self explanatory.

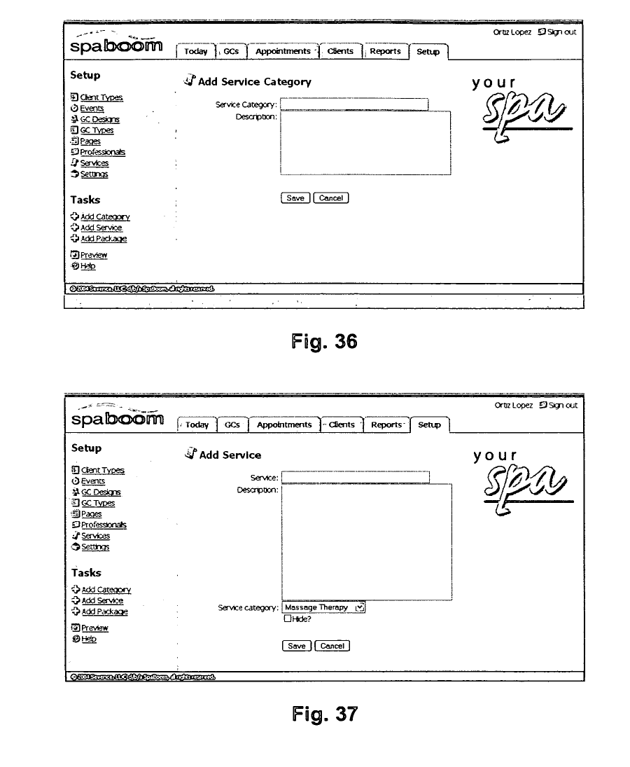

FIG. 36 illustrates the “Add Service Category” page accessed by clicking on the “Add Category” link in the context sensitive tasks menu. The text entry fields are self explanatory.

FIG. 37 illustrates the “Add Service” page accessed by clicking on the “Add Service” link in the context sensitive tasks menu. The text entry fields are self explanatory.

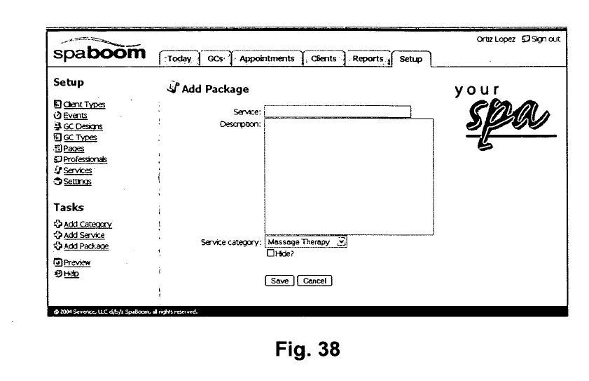

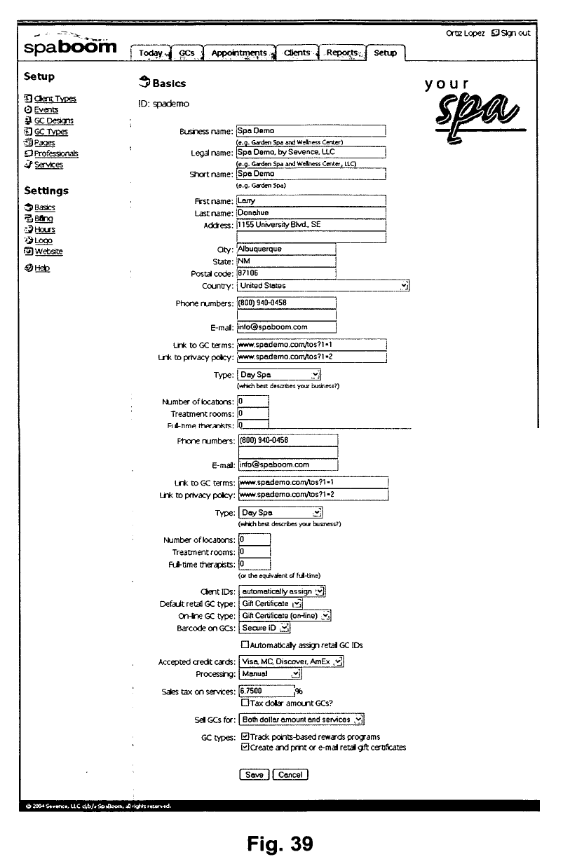

FIG. 38 illustrates the “Add Package” page accessed by clicking on the “Add Package” link in the context sensitive tasks menu. The text entry fields are self explanatory.

FIG. 39 illustrates the “Basics” page accessed by clicking on the “Basics” link in the settings menu. The text entry fields are self explanatory and specify details about a specific services vendor.

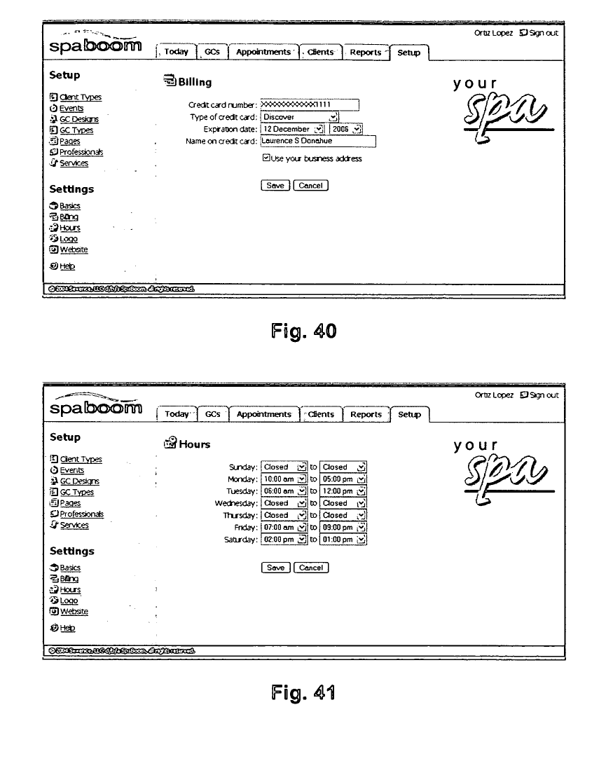

FIG. 40 illustrates the “Billing” page accessed by clicking on the “Billing” link in the settings menu. The text entry fields are self explanatory and specify details required for billing a specific services vendor.

FIG. 41 illustrates the “Hours” page accessed by clicking on the “Hours” link in the settings menu. The text entry fields are self explanatory and specify the hours of operation of a specific services vendor.

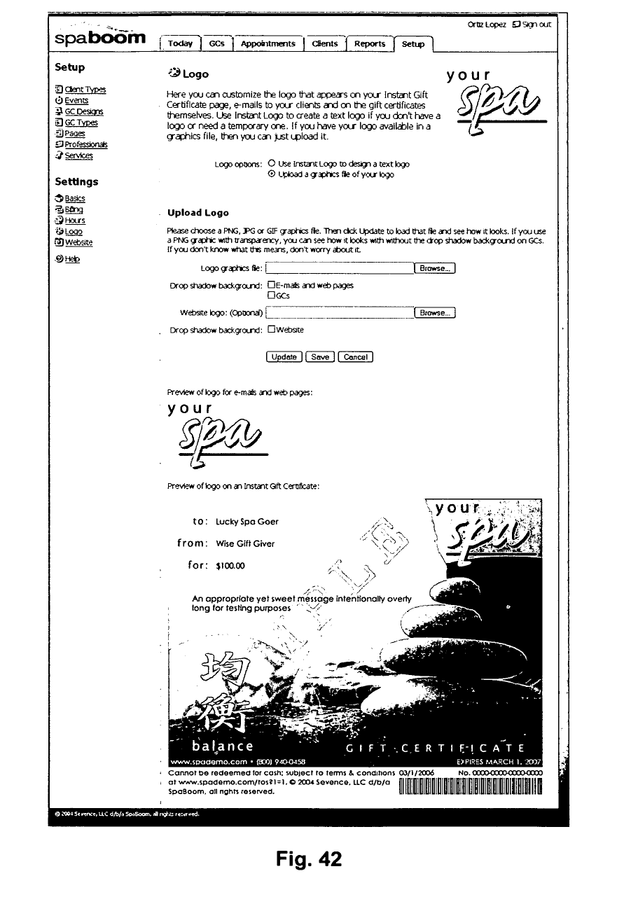

FIG. 42 illustrates the “Logo” page accessed by clicking on the “Logo” link in the settings menu. The page and its function are self explanatory as can be seen by reading the text in the FIG. 42. An example gift certificate is presented at the bottom of the page. Note that the page header and trailer are cropped from FIG. 42.

FIG. 43 illustrates the “Website” page accessed by clicking on the “Website” link in the settings menu. The text entry fields are used to set parameters used in generating a website for the personal services provider.

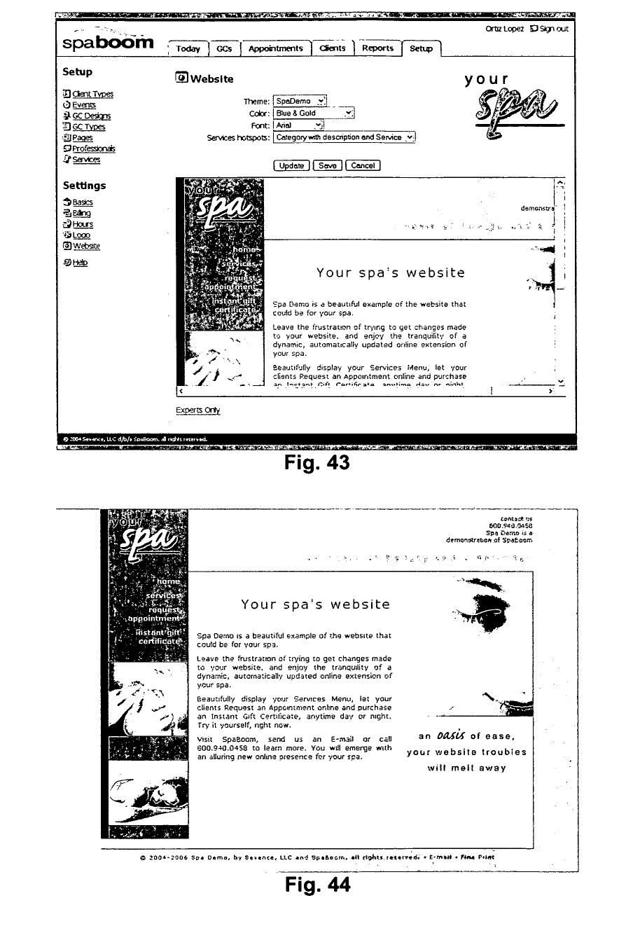

FIG. 44 illustrates the home page for a personal services vendor. All of the elements displayed as a part of the website can be set using the input fields presented in FIGS. 1-43.

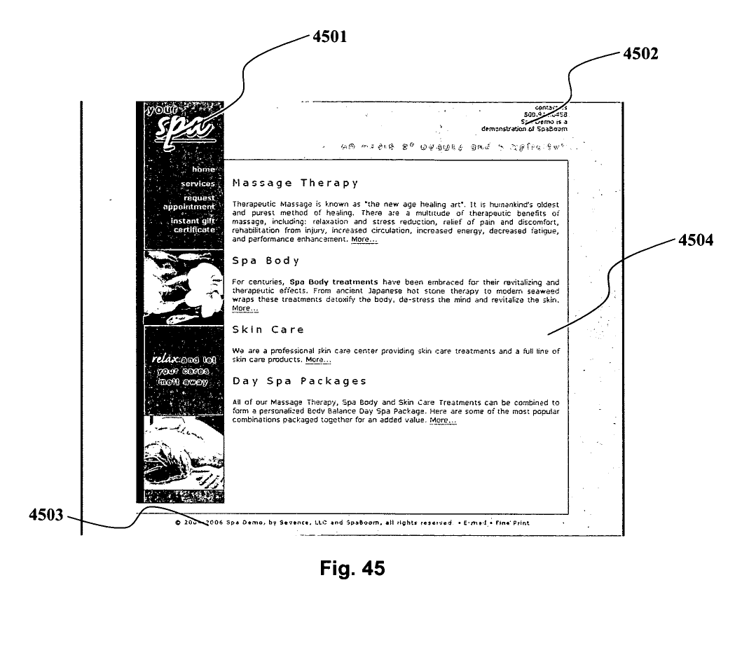

FIG. 45 illustrates the services page of a personal services vendor's website. The sidebar 4501, header 4502, and trailer 4503 are used as common elements in many of the web pages. The service content area 4504 displays service category information matching that input above.

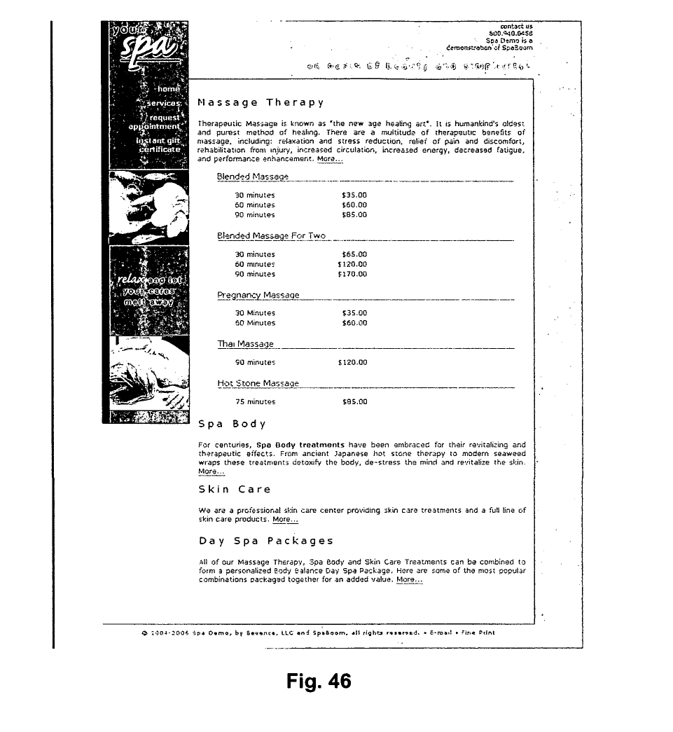

FIG. 46 also illustrates the services page of a personal services vendor's website. The difference between FIG. 45 and FIG. 46 is that the details of specific service offerings in the “Massage Therapy” category are presented. The specific service offerings are displayed because the “more” link associated with “Massage Therapy” has been selected.

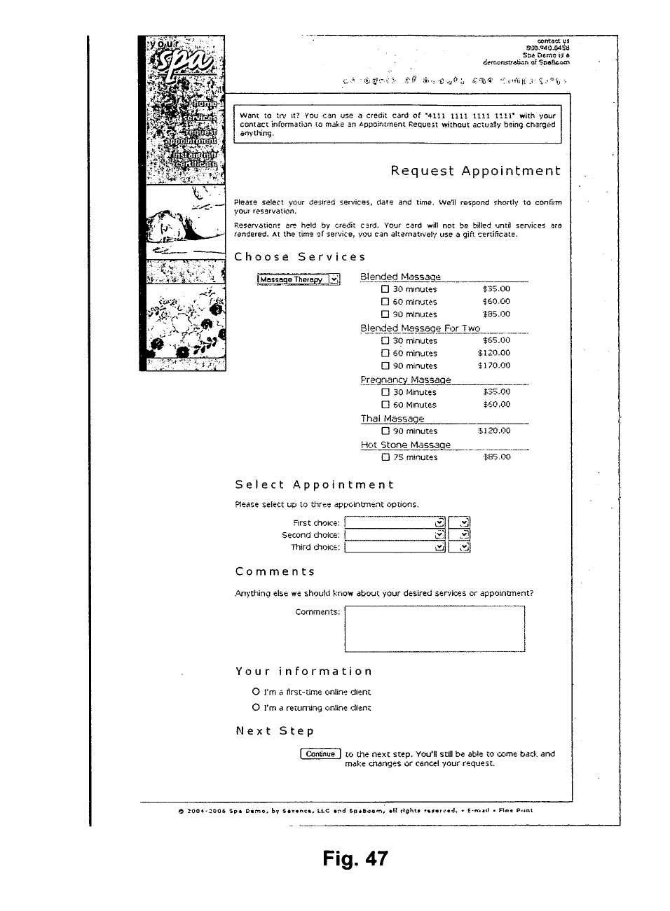

FIG. 47 illustrates the “Request Appointment” first page of a personal services vendor's website. Here, the service category can be selected from a menu. The services in the selected services category are displayed as options. An opportunity to select appointment times and supply comments is presented. A first time or returning client can make an appropriate selection before pressing the continue button.

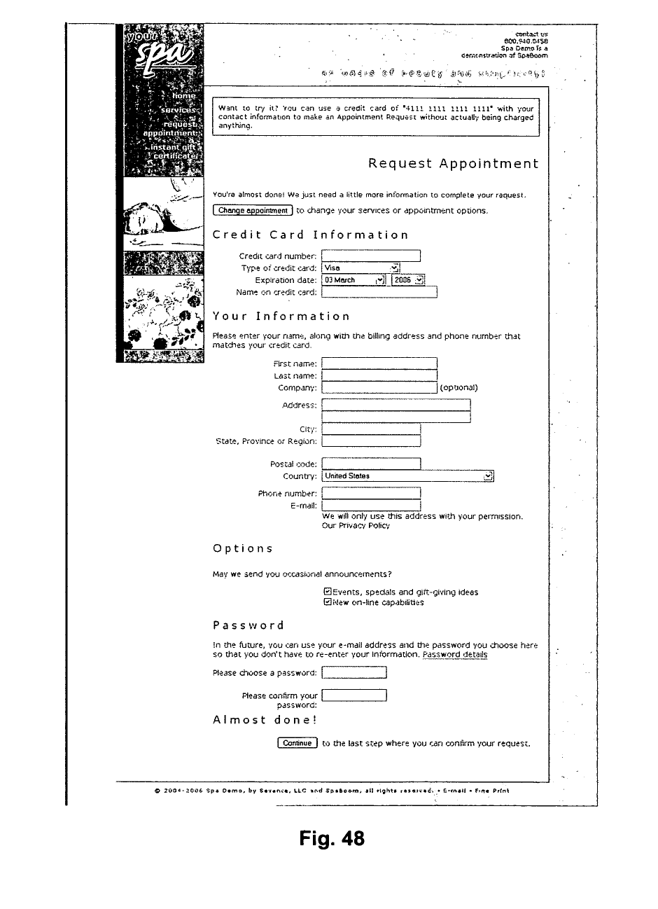

FIG. 48 illustrates the “Request Appointment” client information page of a personal services vendor's website. When “I'm a first time online client” is selected on the page illustrated in FIG. 47 and “continue” is selected, then the client is prompted for information that can be used to set up an account for that client. The client information can be stored in a client database.

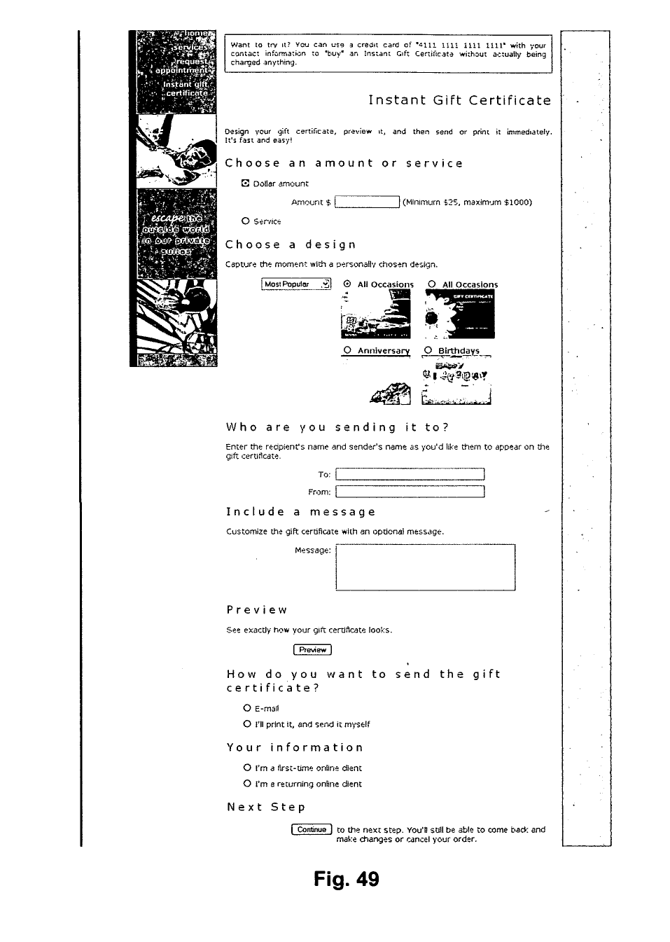

FIG. 49 illustrates the “Instant Gift Certificate” first page of a personal services vendor's website. A dollar amount or a service can be selected using radio buttons. Here, “Dollar amount” is selected. A customer can select the category of gift certificate design, as well as the particular design of interest. Considering the information of FIGS. 1-43, the remainder of the text is self explanatory. At the bottom of the page, the client is given two fulfillment options: email or print. The client can print out the gift certificate and then deliver it. Alternatively, an email containing the gift certificate can be automatically generated and electronically mailed to the gift recipient. Those practiced in the art of online fulfillment know of numerous ways to email a gift certificate. For example, an image file containing an electronic image of the gift certificate can be mailed. The gift buyer can receive a voided copy of the electronic gift certificate and a receipt.

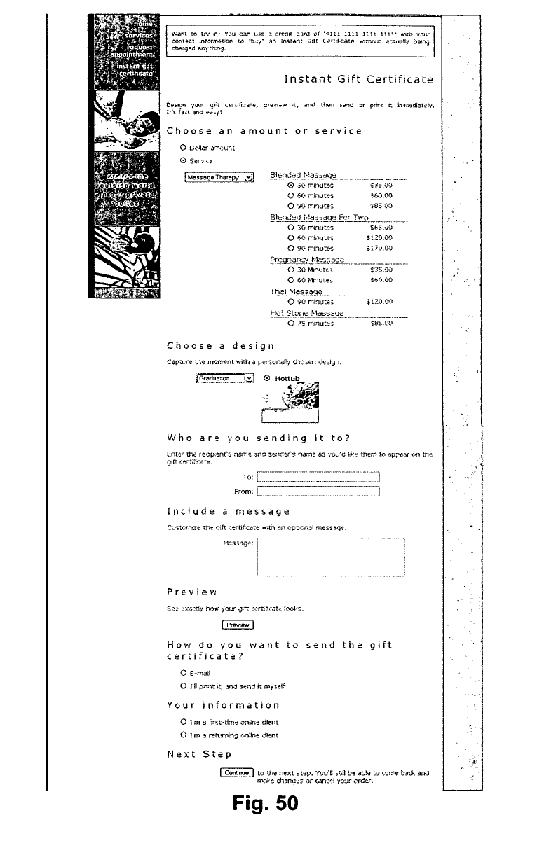

FIG. 50 illustrates the “Instant Gift Certificate” first page of a personal services vendor's website wherein the “Service” radio button is selected. As such, the service category menu and specific services, as previously discussed in relation to FIG. 47, is displayed.

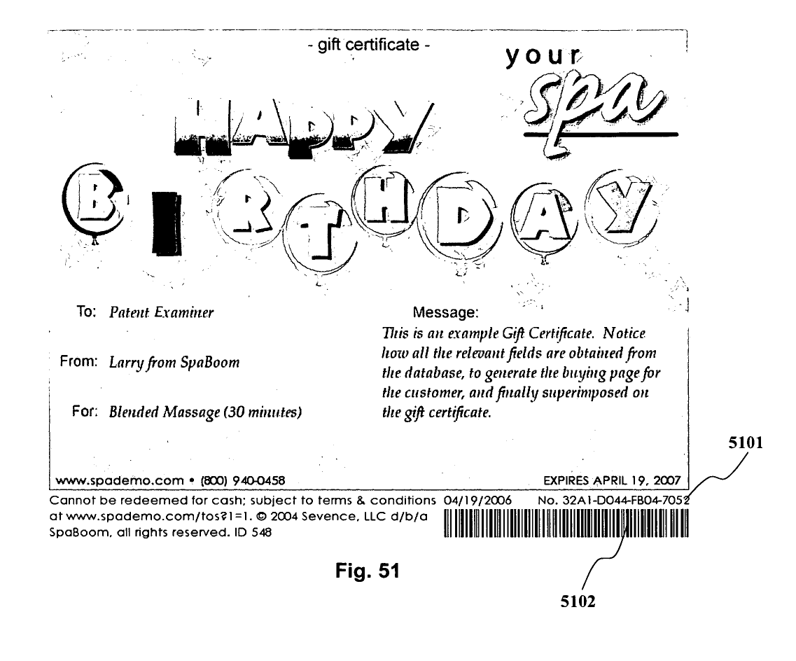

FIG. 51 illustrates the final product: an actual “Instant Gift Certificate” that a customer receives, once they have completed a purchase. The logo, website address and phone number of the relevant organization is superimposed on the image. The data fields required to form a valid gift certificate are also superimposed on the image. Those data fields include customized “To message”, “From message”, and “General message”, as well as, the amount of service, the expiration date, a security number 5101, bar code 5102, purchase date, reference to legal terms and conditions, and the gift certificate ID number. Notice that legal terms and conditions can be customized based on the organization's jurisdiction.

Embodiments can be implemented in the context of modules. In the computer programming arts, a module (e.g., a software module) can be implemented as a collection of routines and data structures that perform particular tasks or implement a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term “module”, as utilized herein generally refers to software modules or implementations thereof. Such modules can be utilized separately or together to form a program product that can be implemented through signal-bearing media, including transmission media and recordable media.

The examples discussed above are intended to illustrate aspects of the embodiments. The phrases “an embodiment”, “some embodiments”, or “certain embodiments” do not necessarily refer to the same embodiment or any specific embodiment.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method comprising:
providing a management interface comprising at least one management page comprising a web site design interface that provides at least one template;
providing access to the at least one management interface to an organization such that the organization is provided with an organization web site based on a default web site and wherein the organization can use the web site design interface to customize the organization web site;
hosting the organization web site;
providing a customer database and providing at least one customer management page that can be used for accessing the customer database; and
providing a services database and providing at least one services management page that can be used for accessing the services database.

2. The method of claim 1 further comprising:
providing a gift certificate management module and at least one gift certificate management page that can be used for specifying at least one gift certificate type wherein the at least one gift certificate type comprises terms and conditions.

3. The method of claim 1 further comprising:
providing a jurisdiction based optimization module that uses a legal jurisdiction in which the organization does business to specify terms and conditions.

4. The method of claim 3 further comprising providing to a customer at least one gift certificate page within the organization web site wherein the customer can purchase a gift certificate comprising the terms and conditions.

5. The method of claim 1 further comprising:
presenting a search interface to a customer wherein the customer can select at least one search factor;
searching for at least one suitable organization based on the at least one search factor and reporting the at least one suitable organization to the customer;
obtaining a selected organization from the customer wherein the selected organization is one of the at least one suitable organization;
presenting to the customer at least one description of at least one service provided by the selected organization;
obtaining billing information and desired service information from the customer; and
providing a gift certificate to the customer wherein the gift certificate is branded and numbered for the selected organization.

6. The method of claim 5 further comprising notifying the selected organization and providing the selected organization with customer information comprising the billing information such that the selected organization can process the billing information and receive a payment.

7. A method comprising:
providing a management interface comprising at least one management page comprising a web site design interface that provides at least one template that can be used to customize a web site;
providing an organization with access to the at least one management interface such that the organization is provided with an organization web site based on a default web site and wherein the organization can use the web site design interface to customize the organization web site;
hosting the organization web site;
providing a customer database and providing at least one customer management page that can be used for accessing the customer database; and
providing a services database and providing at least one services management page that can be used for accessing the services database.
providing a product database comprising at least one product record and wherein each one of the at least one product record comprises a price and an identifier;
providing a product selection interface to the organization wherein the organization can select zero or more product records to produce a products offering; and
using a product template to integrate the products offering into the organization website.

8. The method of claim 7 further comprising:
accepting a product order from a one customer wherein the customer uses the web site to create the product order; and
fulfilling the product order.

9. The method of claim 7 further comprising:
obtaining branded packaging wherein the branded packaging compromises at least one customized element conveying a brand; and
using the branded packaging to fulfill the product order.

10. The method of claim 7 wherein the template is a branded template comprising at least one customized element conveying a brand.

11. The method of claim 7 further comprising:
providing a gift certificate management module and at least one gift certificate management page that can be used for specifying at least one gift certificate type wherein the at least one gift certificate type comprises terms and conditions.

12. The method of claim 7 further comprising:
providing a jurisdiction based optimization module that uses a legal jurisdiction in which the organization does business to specify the terms and conditions.

13. The method of claim 12 further comprising providing to a customer at least one gift certificate page within the organization web site wherein the customer can purchase a gift certificate comprising the terms and conditions.

14. The method of claim 7 further comprising:
presenting a search interface to a customer wherein the customer can select at least one search factor;
searching for at least one suitable organization based on the at least one search factor and reporting the at least one suitable organization to the customer;
obtaining a selected organization from the customer wherein the selected organization is one of the at least one suitable organization;
presenting to the customer at least one description of at least one service provided by the selected organization;
obtaining billing information and desired service information from the customer;
and
providing a gift certificate to the customer wherein the gift certificate is branded and numbered for the selected organization.

15. The method of claim 14 further comprising notifying the selected organization and providing the selected organization with customer information comprising the billing information such that the selected organization can process the billing information and receive a payment.

16. A system comprising:
a management interface comprising at least one management page comprising a web site design interface that provides at least one template that can be used to customize a web site;
a web site hosting module that can host at least one web site wherein at least one of the at least one web site is an organization web site associated with an organization and wherein the organization can use the web site design interface to customize the organization web site;
a customer database and at least one customer management page that can be used for accessing the customer database; and
a services database and at least one services management page that can be used for accessing the services database.

17. The system of claim 16 further comprising:
a jurisdiction based optimization module that uses a legal jurisdiction in which the organization does business to specify the terms and conditions.

18. The system of claim 17 further comprising:
a gift certificate management module and at least one gift certificate management page that can be used for specifying at least one gift certificate type wherein the at least one gift certificate type comprises terms and conditions; and
at least one gift certificate page within the organization web site wherein the customer can purchase a gift certificate comprising the terms and conditions.

19. The system of claim 16 further comprising:
a product database comprising at least one product record and wherein each one of the at least one product record comprises a price and an identifier;
a product selection interface wherein the organization can use the product selection interface to select zero or more product records to produce a products offering;
a product template for integrating the products offering into the website; and
an ordering interface that a customer can use to create a product order.

20. The system of claim 16 further comprising:
a search interface wherein a customer can select at least one search factor;
at least one suitable organization found by searching based on the at least one search factor;
a selected organization wherein the customer chooses the selected organization from among the at least one suitable organization; and
a gift certificate module that produces a gift certificate for the customer wherein the gift certificate is branded and numbered for the selected organization.
